(19) United States
(12) Patent Application Publication
(10) Pub. No.: US 2002/0057458 A1
(43) Pub. Date: May 16, 2002

(54) Image subdivision for reassembly into composite entity

(76) Inventors: Cullen Davis, Mt. Pleasant, SC (US); Bruce Mottin II, Mt. Pleasant, SC (US)

Correspondence Address: B. Craig Killough, Barnwell Whaley Patterson & Helms, LLC, Suite 300, 134 Meeting Street, Charleston, SC, 29401, US

(21) Appl. No.: 09/992,432

(22) Filed: Nov. 14, 2001

Related U.S. Application Data
(60) Provisional application No. 60/248,300, filed on Nov. 14, 2000.

(51) Int. Cl. G06K 1/00

(52) U.S. Cl. 358/1.18

(57) ABSTRACT

A process of creating a large printed image by the formation of smaller printed digitally images which are subsequently assembled to create the large image. The process accounts for spaces between the smaller images, such as smaller images which are printed on individual ceramic tiles which are assembled with grout spaces between them.

Applicant claims the priority of application Ser. No. 60/248,300 filed Nov. 14, 2000.

### BACKGROUND OF THE INVENTION

In some applications, it is desirable to form a large printed image from the orderly assembly of a group of smaller printed images. It may be inconvenient or impractical to print the large image as a single unit due to factors such as size, or due to the characteristics of the substrate on which the image is to appear. For example, the image may be too large to run through a digital printer. The image can be printed in smaller units and then assembled into a larger image as desired.

If an image is to appear on a large wall formed of ceramic tiles, it is necessary to apply the image to individual tiles, which are subsequently assembled to form the wall. The individual tiles cannot be assembled and run through a printer to print the image. Rather, the image is applied to each tile, such as by transfer printing, and the tiles are then assembled. In this case, and in other examples, it is necessary to account for the area between the tile units in forming the image on the tiles.

### SUMMARY OF THE PROCESS STEPS OF THE INVENTION

1) Acquire and/or create a digital image.

2) Define dimensions of the subcomponent entity. Sub-component entity is defined as the unit that will be used to construct the composite image.

3) Define dimensions of the composite entity. Composite entity is defined as the entity that is composed by combining the all of the subcomponent entities ordered in a specific sequence.

4) Define the width of the assembly spacing. Assembly spacing is defined as the area between the subcomponents that will not contain any of the digital image information.

5) Resize the digital image to match the dimensions of the composite entity.

6) Decompose the digital image into discrete subcomponents corresponding to the subcomponent entities location in the composite image.

7) Display a representation of the composite entity to the user.

8) Define the inter-spacing output dimensions that will separate the subcomponents when they are sent to an output device.

9) Render the digital subcomponents to the output device.

10) For output that was rendered onto a carrier substrate, the subcomponent digital information can be affixed, transferred, or imaged onto to the surface of the final substrate.

### DETAILED EXPLANATION OF THE PROCESS STEPS

This invention is a process for subdividing a digital image into subcomponents, optimizing the components to match the physical characteristics of the final substrate on which the image is to appear, and to allow for assembly of the subcomponents into a composite entity.

1) Acquire And/or Create Digital Image

The process involves first acquiring a digital image through any method known in the art. Examples include, but are not limited to scanning, video capture, digital photography, raster image creation software, and vector image creation software.

2) Define Dimensions of the Sub-component Entity. Sub-component Entity is Defined as the Single Unit that will be used to Construct the Composite Image.

The dimensions of the subcomponent entity are defined to completely enclose the desired subcomponent when rendered at full size. The term “subcomponent entity” is defined as the single smaller unit or units of the substrate that will be used to construct the composite image. Examples of a subcomponent entity are a ceramic tile, a block of wood, and a quilt patch.

3) Define Dimensions of the Composite Entity. Composite Entity is Defined as the Final Entity that is Composed of the total of the Sub-component Entities Ordered in a Specific Array Sequence.

The dimensions of the composite entity are then defined to completely enclose the desired area when rendered full size. The term “composite image” or “composite entity” is defined as total of the subcomponent entities ordered in a specific array sequence to display the entire image as printed on the individual subcomponent substrates. The unit of measure for the composite entity may be specified in subcomponent units. For example, if each subcomponent dimension is 50 cm by 50 cm, and the composite entity is 500 cm×500 cm, the dimensions of the composite image can be specified as 10 subcomponent units wide by 10 subcomponent units high.

4) Define the Width of the Assembly Spacing. Assembly Spacing is Defined as the Area between the Sub-components that will not Contain any of the Digital Image Information.

Define the width of the assembly spacing. The term “assembly spacing” is defined as the area between the subcomponents that will not contain any of the digital image information. The spacing is specified to account for surface area on the composite entity that will be used to connect the subcomponent entities. Examples may be the grout area of a tile mural or the seam spacing between panels on a quilt.

5) Resize the Digital Image to Match the Dimensions of the Composite Entity.

If the dimensions of the composite image do not match the dimensions of the digital image, the digital image is resized. The dimensions of the subcomponent entity, the dimensions of the composite entity, the assembly spacing, and the aspect ratio of the digital image are analyzed to determine the optimal resize dimensions. The digital image is scaled until both the height and width fit the dimensions required by the composite entity. The process of scaling the image will enhance the quality of the pixel data in the image if it is scaled to a smaller size. The scaling process will preserve the quality of the pixel data if the image is scaled to a larger size. The scaling will always preserve the aspect ratio of the digital image. The aspect ratio is defined as the proportion of width to height (width/height).

6) Decompose the Digital Image into Discrete Sub-components Corresponding to the Sub-component Entities Location in the Composite Image.

Using the resized composite image, a two dimensional array of discreet subcomponent images are then created. Each subcomponent image array element is comprised of the digital pixels in the corresponding area of the resized composite image. The dimension of each subcomponent image corresponds to the dimensions of the subcomponent entity. The number of subcomponent entities created is equal to the composite entity's width times the composite entity's height. The origin of the subcomponent image array is initially set at the upper left edge of the resized digital image.

7) Display a Representation of the Composite Entity to the User.

A representation of the composite entity is displayed to the user. The subcomponents are displayed as a superimposed grid on top of the digital image. The user can modify the composite entity by;

Modifying the origin of the subcomponent image array

Modifying the number of subcomponents in the x dimension of the array

Modifying the number of subcomponents in the y dimension of the array

8) Define the Inter-spacing Output Dimensions that will Separate the Sub-components when they are Sent to an Output Device.

The inter-spacing output dimensions are specified. Inter-spacing output dimensions define the size of the borders or “white space” that surrounds each subcomponent entity when it is rendered full size to a physical output device. The user specifies which elements of the subcomponent image array are to be rendered to the output device. This can include the entire array or any sub-set of the array. The placement of the subcomponent image on the output device may be optimized to maximize the number of subcomponents on the surface of the output device. The placement of the subcomponent images may also be optimized for the physical properties and/or dimensions of the composite entity. An additional optimization step may include the color correction of the digital image, optimized for the substrate of the composite entity. The subcomponent digital image information and subcomponent assembly information, including but not limited to, array location and sizing marks are rendered to the output device. The output device may be, for example, a digital appliance, such as an inkjet, phase change, electrographic or wax thermal printer; or devices used in conventional printing methods such as relief, planographic and intaglio printing, where a relief plate, a planographic plate, or a gravure plate, respectively, are used as the image carrier.

9) Render the Digital Sub-components to the Output Device.

The subcomponent digital image information can be rendered directly onto the substrate that will be used to construct the composite entity, or if required, indirectly onto a carrier substrate. If the subcomponent digital image is rendered onto a carrier substrate, subcomponent orientation marks may be printed on the carrier substrate. The orientation marks allow the final substrate subcomponent to be perfectly aligned with the carrier substrate during step ten. If the subcomponent digital image is rendered onto a carrier substrate, substrate identifiers may be printed on the carrier substrate. The identifiers allow for the subcomponents to be marked so they can be quickly identified when the final composite object is constructed in step ten.

10) For Output that was Rendered onto a Carrier Substrate, the Sub-component Digital Information can be Affixed, Transferred, or Imaged onto to the Surface of the Final Substrate.

For output that was rendered onto a carrier substrate, the subcomponent digital information can be affixed, transferred, or imaged onto to the surface of the final substrate. An example of direct rendering onto the composite entity substrate is direct print fabric inkjet. An example of indirect rendering is wax thermal printing of an image onto paper, with the image subsequently sublimated and transferred from the paper on to tile. The subcomponents are then arranged according to the subcomponent array information to form the composite entity.

### EXAMPLES

An example of a use for the above-described process would be to prepare a ceramic mural. In one example, an inkjet printer is used as the output device and sublimation inks are used to print the subcomponents to an intermediate media, such as paper. After printing the subcomponents, each subcomponent is then separately applied to a coated ceramic tile with the printed side facing the coated tile. Heat and pressure are then applied to the backside of the printed image. The image is sublimated from the intermediate media to the coated tile. The thus obtained imaged tile is then placed in its proper sequence to form the final mural.

Another example for this process is the creation of quilt panels for assembly into a quilt. For example, a customer provides a photograph of an infant to the user of this process. The photograph is converted into a digital image, and the dimensions of the final quilt and the quilt panels are specified. The process creates an array of quilt panels that are output to a direct-to-fabric inkjet printer. The quilt panels are then assembled into a customized baby quilt.

Another example for this process is the creation of a 3-dimensional-puzzle cube. In this example, the puzzle cube consists of six sides with each side comprised of nine sub-units. A photograph is scanned and converted into a digital image. The dimensions of the puzzle cube are specified and the process breaks the image into a collection of nine element subcomponent arrays, one for each side of the cube. The subcomponents are color corrected and are rendered onto paper using a LaserJet printer. The subcomponents are then laminated to the sub-units on each side of the puzzle cube.

What is claimed is:

1. A method of digitally producing a composite image that comprises a plurality of subcomponent images, comprising the steps of:
a. defining a length and a width of each of a plurality of discrete digital subcomponent entities to equal the length and width of individual substrates to be printed upon;
b. defining a length and a width of a composite image;
c. defining at least one width of assembly spacing that is required to be present between each of said plurality of discrete digital subcomponent entities;
d. sizing a digital image to comprise a length and width that is equal to a length and width of said composite image;
e. decomposing said digital image into said plurality of discrete digital subcomponent entities, wherein each of said plurality of discrete digital subcomponent entities has a length and width as defined, and wherein a sum of said plurality of discrete digital subcomponent entities plus a sum of widths of assembly spacing that is required between each of said plurality of discrete digital subcomponent entities equals said length and width of said digital image;
f. tendering said plurality of discrete digital subcomponent entities to a printer; and
g. printing each of said plurality of discrete digital subcomponent entities upon a corresponding substrate of said individual substrates by means of said printer, to produce a plurality of discrete printed subcomponent entities.

2. A method of digitally printing a composite image that comprises a plurality of subcomponent images as described in claim 1, further comprising the step of assembling said plurality of discrete printed subcomponent entities according to said composite image.

3. A method of digitally printing a composite image that comprises a plurality of subcomponent images as described in claim 1, further comprising the step of printing subcomponent orientation marks onto said substrate.

4. A method of digitally producing a composite image that comprises a plurality of subcomponent images, comprising the steps of:
a. defining a length and a width of each of a plurality of discrete digital subcomponent entities to equal the length and width of each of individual substrates;
b. defining a length and a width of a composite image;
c. defining at least one width of assembly spacing that is required to be present between each of said plurality of discrete digital subcomponent entities;
d. sizing a digital image to comprise a length and width that is equal to a length and width of said composite image;
e. decomposing said digital image into said plurality of discrete digital subcomponent entities, wherein each of said plurality of discrete digital subcomponent entities has a length and width as defined, and wherein a sum of said plurality of discrete digital subcomponent entities plus a sum of widths of assembly spacing that is required between each of said plurality of discrete digital subcomponent entities equals said length and width of said digital image;
f. tendering said plurality of discrete digital subcomponent entities to a printer;
g. printing each of said plurality of discrete digital subcomponent entities upon at least one substrate by means of said printer, to produce a plurality of discrete printed subcomponent entities; and
h. transferring each of said plurality of discrete printed subcomponent entities from said at least one substrate to a corresponding substrate of each of said individual substrates to produce a plurality of discrete transferred subcomponent entities.

5. A method of digitally printing a composite image that comprises a plurality of subcomponent images as described in claim 4, further comprising the step of assembling said plurality of discrete transferred subcomponent entities according to said composite image.

6. A method of digitally printing a composite image that comprises a plurality of subcomponent images as described in claim 4, further comprising the step of printing subcomponent orientation marks onto said at least one substrate.
